(19) United States
(12) Patent Application Publication
(10) Pub. No.: US 2020/0032961 A1
(43) Pub. Date: Jan. 30, 2020

(54) Protective Cap with Top and Rear Handles for Gas Cylinder

(71) Applicant: Luxembourg Patent Company S.A., Lintgen (LU)

(72) Inventors: Eroglu Volkan, Luxembourg (LU); Jean-Claude Schmitz, Heisdorf (LU)

(73) Assignee: Luxembourg Patent Company S.A., Lintgen (LU)

(21) Appl. No.: 16/477,367

(22) PCT Filed: Jan. 12, 2018
(86) PCT No.: PCT/EP2018/050788

§ 371 Date: Jul. 11, 2019

(30) Foreign Application Priority Data
Jan. 13, 2017 (LU) LU100020

(51) Int. Cl. F17C 13/08; F16K 17/38

(52) U.S. Cl. CPC F17C 13/084; F16K 17/383; F17C 2201/032; F17C 2205/0308; F17C 2201/0109; F17C 2205/0329

(57) ABSTRACT

The invention is directed to a protective and/or handling cover (2; 102) for a tap (26; 126) of a gas cylinder assembly (22; 122), said cover comprising a housing (4; 104) for receiving the tap (26; 126); a first handle (6; 106) located at the top of the housing (4; 104); and a second handle (8; 108) located on a rear face (28; 128) of the housing (4; 104), for handling the gas cylinder assembly (22; 122), said handle comprising a rod (8.1; 108.1) forming with a portion of the housing (4; 104) a slot (30; 130) so that said rod can be grasped and encircled through said slot by the fingers of an operator. The portion of the housing forming the slot (30; 130) forms a smooth and continuous surface (32; 132) that extends vertically so as to from a resting surface for the operator's hand.

### TECHNICAL FIELD

The invention is directed to the field of gas cylinders assemblies comprising a gas cylinder, a tap and a protective cap mounted on the tap at the top of the gas cylinder. More specifically, the invention is directed to protective caps for taps of gas cylinder assemblies.

### BACKGROUND ART

Prior art patent document published FR 2 976 048 A1 discloses a protective and handling cap for a gas cylinder assembly. The cap is made of plastic material and is comprised essentially of two half-shells that are assembled to each other. The cap forms a housing that surrounds a tap mounted on the gas cylinder, an upper handle and a lower handle. The housing comprises a threaded bottom neck portion designed for engaging with a corresponding threaded portion on the collar of the gas cylinder. The upper handle of offset with the longitudinal axis of the gas cylinder. The lower handle is formed at the bottom of a rear face of the cap. It is normally formed by the edge portion of a rib whereas a rod-shaped handle forming a slot with the cap is also foreseen. Side gripping handles formed by edges of rib portions are also provided. The presence of several handles, i.e. the upper one, the lower one, and the side ones, is interesting in that it allows different gripping positions for an operator. The cap is however of a sophisticated construction. The proper formation of the bottom threaded neck portion requires a high precision in the manufacturing and assembling of the two half-shells. Also, the lower handle presents a limited comfort, essentially in that the cylinder can oscillate while being carried, with little, if any, possibility of control. In addition, the upper handle by being offset implies that the cylinder will be slightly tilted when carried by this handle.

Prior art patent document published FR 2 706 016 A1 discloses also a protective and handling cap for a gas cylinder assembly. The cap forms a housing that surrounds a tap mounted on the gas cylinder, an upper handle and a lower handle. Both upper and lower handles are offset with the longitudinal axis on a rear side of the housing. The cap comprises also a collar to be slip and tightened on an outer surface of a shoulder at the neck of the gas cylinder. Similarly to the cap of the preceding document, such a construction requires a certain level of accuracy in the manufacture of the cap for achieving a proper mounting. In addition, this requires also a high stiffness and mechanical resistance. Also, the lower handle fails to provide a comfortable and safe handling in view of the fact that it is merely formed by a lower edge of the wall forming the rear face.

Prior art patent document published JP 2002-61799 A discloses also a protective and handling cap for a gas cylinder assembly. The cap is formed of two half-shells assembled to each other. The cap comprises an upper handle on the front half-shell and a lower handle on the rear half-shell. Similarly to the preceding document, the lower handle fails to provide a comfortable and safe handling in view of the fact that it is merely formed by a lower edge of the wall forming the rear face.

### SUMMARY OF INVENTION

### Technical Problem

The invention has for technical problem to provide a cap for the tap of a gas cylinder assembly that overcomes at least one drawback of the above cited prior art. More specifically, the invention has for technical problem to provide a gas cylinder cap with a better handling and of simpler construction.

### Technical Solution

The invention is directed to a protective and/or handling cover for a tap of a gas cylinder assembly, said cover comprising: a housing for receiving the tap, with a front face and a rear face; a first handle located at the top of the housing for handling the gas cylinder assembly; a second handle located on the rear face of the housing, for handling the gas cylinder assembly, said handle comprising a rod forming with a portion of the housing a slot so that said rod can be grasped and encircled through said slot by the fingers of an operator; wherein the portion of the housing forming the slot forms a continuous surface that extends vertically so as to from a resting surface for the operator's hand.

According to a preferred embodiment, the continuous resting surface extends vertically over at least 50 mm, preferably at least 60 mm, more preferably at least 70 mm.

According to a preferred embodiment, the continuous resting surface extends horizontally over at least 50 mm, preferably at least 60 mm, more preferably at least 70 mm

According to a preferred embodiment, the rod of the second handle shows a cross-sectional profile that is polygonal, preferably rectangular, parallelogram-shaped or triangular, with rounded corners.

According to a preferred embodiment, the housing comprises an opening on the front face, for receiving a dial or display of the tap, the rod of the second handle being located at the height of said opening.

According to a preferred embodiment, the housing comprises a top face with an opening for receiving a flow and/or pressure selector of the tap, the first handle forming an arch upright of said opening.

According to a preferred embodiment, the rod of the second handle extends generally horizontally below the continuous resting surface.

According to a preferred embodiment, the slot shows an average width comprised between 10 and 20 mm, preferably between 12 and 18 mm, more preferably between 14 mm and 16 mm.

According to a preferred embodiment, a horizontal section of the continuous resting surface shows a curved profile with a convexity oriented rearwards, and preferably with an average radius comprised between 80 mm and 160 mm, preferably between 100 mm and 140 mm

According to a preferred embodiment, the rod of the second handle shows a rear face that is aligned with the continuous resting surface.

According to a preferred embodiment, the rod of the second handle extends generally vertically. In that context, the fact that the portion of the housing forming the slot forms a continuous surface that extends vertically so as to from a resting surface for the operator's hand can be optional.

According to a preferred embodiment, the rod of the second handle extends along and in front of the continuous resting surface.

According to a preferred embodiment, the rod of the second handle extends along a whole height of the continuous resting surface.

According to a preferred embodiment, the rod of the second handle shows a rear face that is generally flat and a front face this is generally curved or rounded.

According to a preferred embodiment, the rod of the second handle extends from a bottom of the housing to the top face of said housing.

According to a preferred embodiment, the housing comprises two opposite sides faces, each of said side faces comprising a bottom edge with a curved profile showing a concavity oriented downwardly.

According to a preferred embodiment, each side face of the housing comprises a curved protective rib that extends transversally and outwardly from said face.

According to a preferred embodiment, each side face of the housing comprises at least one fixation hole for receiving a transversal fixation screw to engage with the tap.

According to a preferred embodiment, the at least one fixation hole is located below the curved protective rib on the side face of said at least one fixation hole.

The invention is also directed to a gas cylinder assembly comprising: a gas cylinder with a top collar; a tap mounted on the collar of the gas cylinder; a protective and/or handling cap housing the tap; wherein the protective and/or handling cap is according to the invention, said cap being attached directly to the tap.

### Advantages of the Invention

The invention is particularly interesting in that it provides an improved construction of the cap in that it provides a better gripping of the rear handle. Generally speaking, the upper handle on a gas cylinder assembly is preferably used for carrying short and/or light cylinders. With the upper handle, the cylinder remains essentially straight. The upper handle is also useful for manipulating the gas cylinder like adjusting its position and tilting it for making it rolling on the floor around its bottom periphery. The rear handle is mainly for carrying the gas cylinder and shows a double advantage, namely that the gripping level is lower and that the cylinder tends to tilt when being lifted. For an operator of a given size, the bottom handle enables to carry gas cylinders that are higher and/or heavier. For such situations, an ergonomic handle is desired and is achieved by the measures of the invention. Indeed, the fact of providing a continuous resting surface at the rear handle provides improved ergonomics, essentially in that it allows a proper and safe contact with the hand of the operator. In combination with a horizontal rear handle, it provides a very useful and practical resting surface for the palm of the operator's hand. In combination with a vertical rear handle, it provides a useful and practical resting surface for the outer surface of the curled fingers when entering the slot between the handle and the surface.

The position of the upper handle offset from the longitudinal axis towards to the rear face of the housing is also interesting because it facilitates the use of both handles, i.e. the upper one and the rear one, at the same time. Such a situation can occur under certain handling circumstances, like when loading or moving the cylinder assembly on a vehicle, in particular in a horizontal position.

In addition, the protective ribs on the side provide an additional handling possibility, thereby conveying even more comfort and ergonomics to the cap.

Also the mounting of the cap directly to the tap body is interesting in that it simplifies the construction of the cap and avoids a potentially complicated and time consuming mounting operation on a shoulder portion on the neck of the cylinder.

### BRIEF DESCRIPTION OF THE DRAWINGS

FIG. 1 is a perspective view of a protective and handling cap according to a first embodiment of the invention.

FIG. 2 is a perspective view of the cap of FIG. 1, mounted on a gas cylinder assembly.

FIG. 3 illustrates the gas cylinder assembly of FIG. 2 from another point of view.

FIG. 4 is a rear view of the gas cylinder assembly of FIGS. 2 and 3.

FIG. 5 is a side view of the gas cylinder assembly of FIGS. 2 to 4.

FIG. 6 is a perspective view of a protective and handling cap according to a second embodiment of the invention.

FIG. 7 is a perspective view of the cap of FIG. 6, mounted on a gas cylinder assembly.

FIG. 8 illustrates the gas cylinder assembly of FIG. 7 from another point of view.

FIG. 9 is a rear view of the gas cylinder assembly of FIGS. 7 and 8.

FIG. 10 is a side view of the gas cylinder assembly of FIGS. 7 to 9.

### DESCRIPTION OF AN EMBODIMENT

In the following description, the concepts of “front”, “rear”, “side”, “upper”, “lower” are in relation with the longitudinal axis of the gas cylinder when this latter is in an upright normal position, the front being where the gas output and possible display means are positioned. Also, the protective and handling cap and the corresponding gas cylinder assembly will be described in their normal position, i.e. when the cap is mounted on the gas cylinder in an upright position.

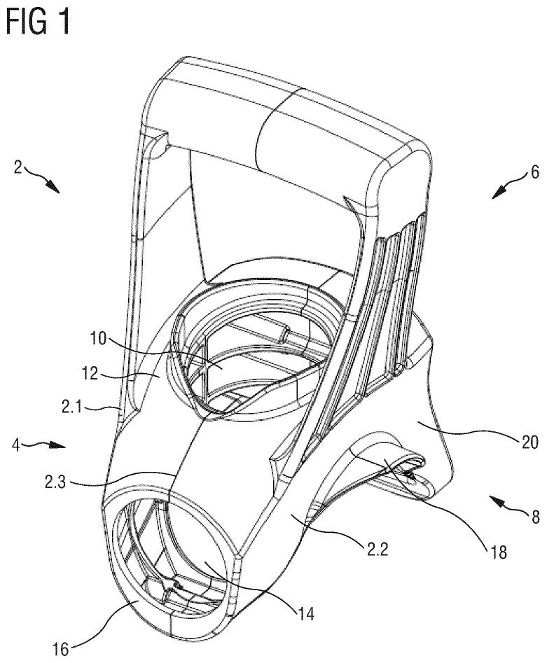

FIGS. 1 to 5 illustrates a first embodiment of the invention.

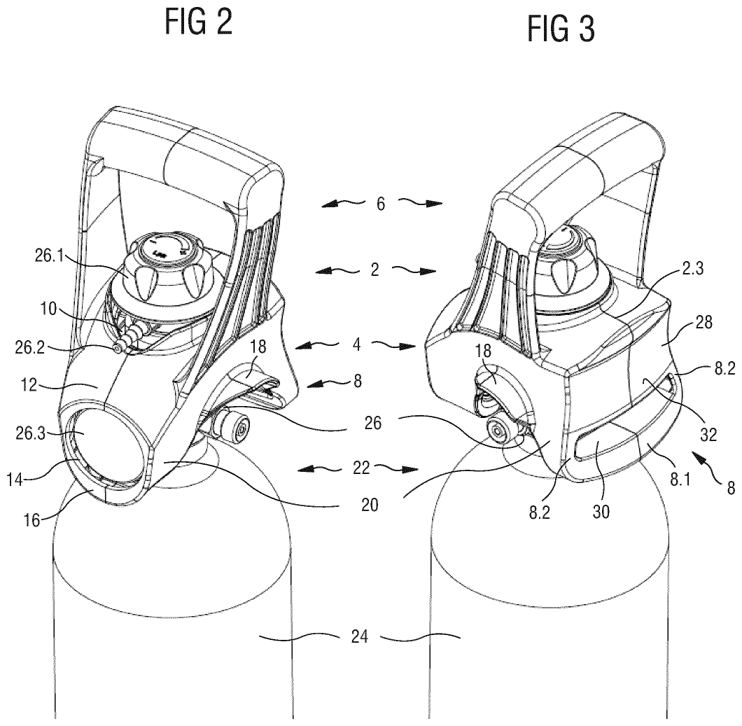

FIG. 1 illustrates in perspective a protective and handling cap 2 for a tap of a gas cylinder (not represented in FIG. 1 but well in FIGS. 2 to 5). The cap 2 comprises, essentially, a central housing 4 that is configured for receiving the tap, an upper handle 6 and a rear handle 8. As this is apparent in FIG. 1, the cap 2 can be made of two half-shells 2.1 and 2.2 that are assembled to each other on a mutual vertical contact plane 2.3 comprising the longitudinal axis of the gas cylinder.

Still with reference to FIG. 1, the housing 4 comprises a first opening 10 on a front face 12 thereof. This opening is intended to receive a hand-wheel of the tap for adjusting the gas flow and/or pressure output. The housing 4 can also comprise a second opening 14 located on a front face 16 thereof. This opening is intended to receive a dial or display of the tap, providing information to a user, e.g. about the output flow/or pressure, and/or about the remaining usage time of the cylinder assembly.

Still with reference to FIG. 1, the cap can comprise also on the housing 4, more specifically on each of the two side faces 20 a rib 18 that extends transversely and outwardly for forming an additional gripping area when handling the gas cylinder assembly and/or for protecting fittings extending transversely.

FIGS. 2 and 3 are two perspective views of a gas cylinder assembly comprising the cap of FIG. 1. The gas cylinder assembly 22 comprises a gas cylinder 24, a tap 26 mounted on the neck of the gas cylinder 24, and the cap 2 assembled to the tap 24.

As visible in FIG. 2, the opening 10 formed on the upper face 12 of the housing 4 receives the adjustment hand-wheel 26.1 and optionally the gas outlet 26.2 that is for instance a hose-barb. The outer surface of a dial or display 26.3 of the tap 26 is schematically represented in the opening 14 formed in the front face of the housing 4.

In FIG. 3, the lower handle 8 is better visible. We can observe that this handle 8 is located at the bottom of the rear face 28 and that it forms a slot 30 with said face. More specifically, the rear face 28 forms a generally smooth and continuous surface 32 that extends vertically downwardly until the slot 30. The lower handle 8 comprises essentially a rod-shaped portion 8.1 that extends essentially horizontally, and two connecting portions 8.2 that extends essentially vertically from the two opposed ends of the rod-shaped portion 8.1 to the housing 4. The slot 30 extends generally horizontally and is dimensioned so as to allow the tips of fingers of an operator to enter said slot when gripping the handle 8. The slot 30 can have a width (measured vertically) comprised between 10 and 20 mm, preferably between 12 and 18 mm, more preferably between 14 mm and 16 mm. Such dimensions of the slot are interesting in that they naturally prevent an operator from inserting his fingers directly into the slot while still allowing the fingers to curl around the handle 8 and at least partly enter said slot from the inner side of the housing.

The continuous surface 32 forms a resting surface for the palm of the operator's hand when gripping the handle 8 and manoeuvring the gas cylinder assembly. Indeed, once the operator has curled the fingers so as to contact and grip the lower handle 8, the palm of the hand, more particularly the upper part thereof, contacts the resting surface 32. This provides an increased comfort and grip quality of the handle 8.

As visible in FIG. 3, the cross-section of the rod-shaped portion 8.1 of the handle 8 can be generally polygonal, for instance quadrilateral with rounded corners. As also visible in FIG. 3, the lower handle 8 is advantageously integrally formed with the housing, with the contact plane 2.3 of the two half-shells of said housing extends through the middle of said handle 8.

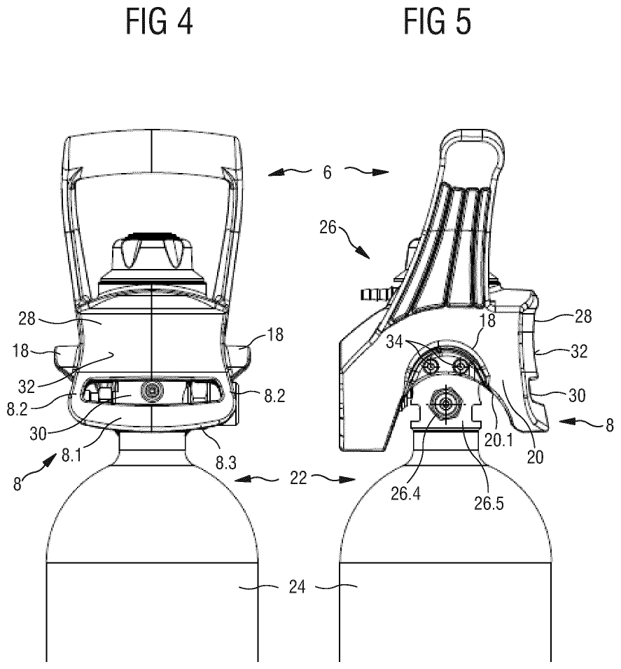

FIGS. 4 and 5 are rear and side views of the gas cylinder assembly of FIGS. 2 and 3.

In FIG. 4, we can observe that the lower handle 8 can show a bottom profile 8.3 that is curved with a concavity oriented upwardly. This profile can have an average radius comprised between 110 mm and 210 mm, preferably between 140 mm and 180 mm. Alternatively, the bottom profile can be generally straight.

In FIG. 5, we can observe that the continuous resting surface 32 is aligned with the corresponding portion of surface on the handle 8. We can also observe that the rear face 28 of the housing 4 of the cap 2 shows a profiled horizontal section that is curved with a convexity directed rearwards. This profile can have an average radius comprised between 80 mm and 160 mm, preferably between 100 mm and 140 mm.

Still in FIG. 5, we can observe that each side face 20 of the housing 4 shows a bottom edge 20.1 that is curved with a cavity that is oriented downwardly. This curved profile 20.1 provides access to a fitting 26.4 that extends laterally from the body 26.5 of the tap 26. In FIG. 5, we can also observe that the side face 20 comprises between the protective rib 18 and the bottom edge 20.1 two holes receiving screws 34 that fasten the housing 4 to the body 26.5 of the tap 26. On each side, the protective rib 18 extends laterally beyond the fitting located below said rib, so as to provide a protection of the fitting in case the gas cylinder would fall sideways.

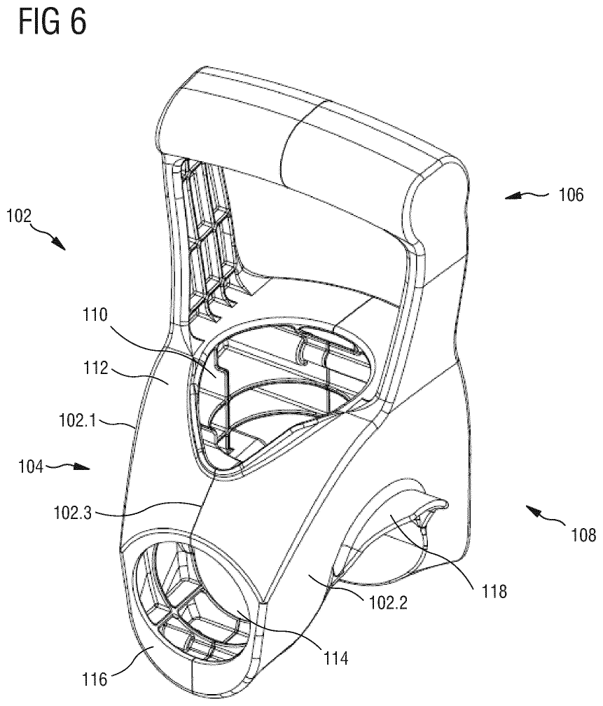

FIGS. 6 to 10 illustrates a second embodiment of the invention. The reference numerals used for the first embodiment are used in the second embodiment for designating the same or corresponding elements, the numeral being however incremented by 100. Reference is made to the description of these elements in the first embodiment. Specific reference numerals comprised between 100 and 200 are used for designating specific elements.

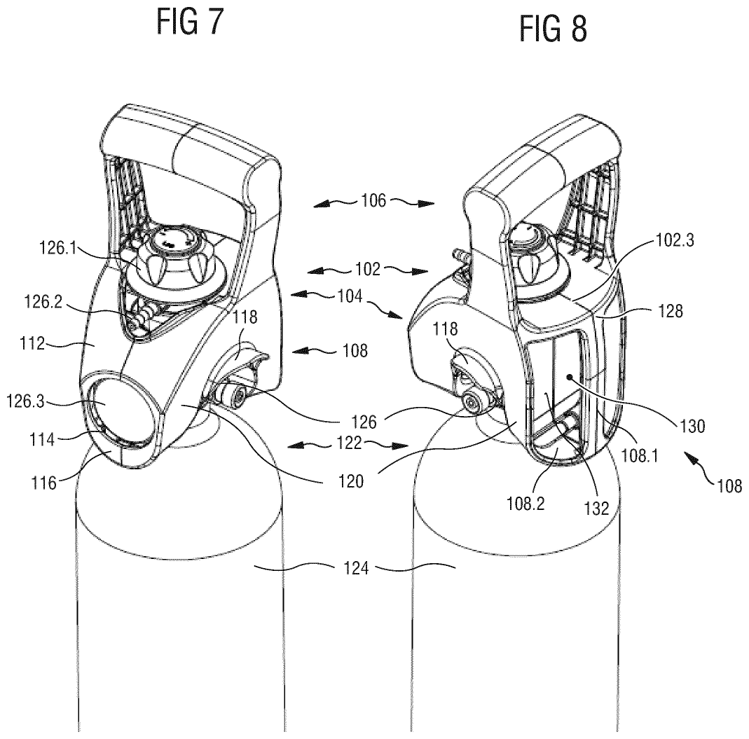

FIG. 6 illustrates in perspective a protective and handling cap 102 for a tap of a gas cylinder (not represented in FIG. 6 but well in FIGS. 7 to 10). The cap 102 is similar to the cap of FIGS. 1 to 5 with the exception of the rear handle 108 that is different.

FIGS. 7 to 10 illustrate the gas cylinder assembly 122 according the second embodiment of the invention.

In FIG. 8, we can observe the rear face 128 of the housing 104 and the rear handle 108. More specifically, we can observe that the rear handle 108 comprises a rod-shaped portion 108.1 that extends essentially vertically along the rear face 128. This portion 108.1 is centred and can be formed of two sub-portions of the respective left and right half-shells of the cap 102, said sub-portion being jointed to each other along the contact plane 102.3. We can also observe that the rear face 128 comprises the continuous surface 132 that is distant from said rod-shaped portion 108.1 so as to form a slot or passage 130 through the fingers of an operator hand can extend when gripping the handle 108. Said handle 108 comprises also two connecting portions 108.2 that extend from the two opposed ends of the rod-shaped portion 108.1 to the housing 104.

The surface 132 located in front of, and distant from, the rod-shaped portion 108.1 of the handle 108 is interesting in that is provide a smooth and comfortable guiding and resting surface for the operator's fingers when gripping the handle.

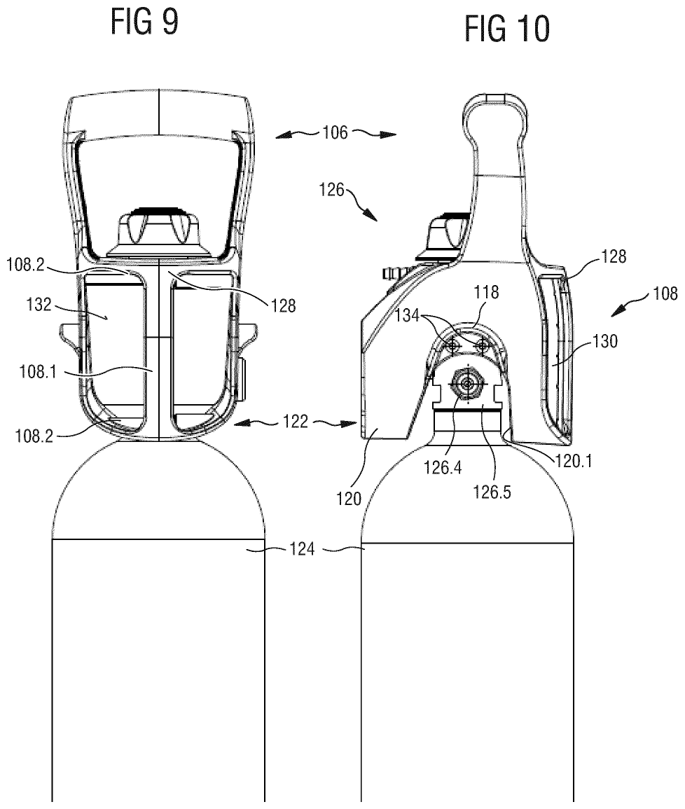

FIG. 9 shows that the continuous resting surface 132 can extend laterally over the whole width of the rear face 128.

In FIG. 10 we can observe that the bottom edge 120.1 of the side face 120 shows a slightly different profile from the profile of the first embodiment. This is essentially due to the fact that the rear face 128 of the housing in this embodiment extends deeper downwards than in the first embodiment, essentially because the rear handle extends now vertically and that free space around the bottom edge of said rear face does not need to be provided anymore. However, similarly to the first embodiment, the curved profile 120.1 provides access to a fitting 126.4 that extends laterally from the body 126.5 of the tap 126. Each side face 120 can also comprise between the rib 118 and the bottom edge 120.1 two holes receiving screws 134 that fasten the housing 104 to the body 126.5 of the tap 126.

The caps which have been described here above are interesting in that they both provide an improved handling while keeping the construction the cap simple, compact and economic.

1.-19. (canceled)

20. A protective and/or handling cover for a tap of a gas cylinder assembly, said protective and/or handling cover comprising:
a housing for receiving the tap, with a front face, a rear face, and a top face with an opening for receiving a flow and/or pressure selector of the tap;
a first handle located at the top of the housing for handling the gas cylinder assembly; and
a second handle located on the rear face of the housing, for handling the gas cylinder assembly, said second handle comprising:
a rod forming with a portion of the housing; and
a slot so that said rod can be grasped and encircled through said slot by the fingers of an operator;
wherein the portion of the housing forming the slot forms a continuous surface that extends vertically so as to form a resting surface for the operator's hand; and
wherein the first handle forms an arch upright of the opening in the top face of the housing.

21. The protective and/or handling cover according to claim 20, wherein the continuous resting surface extends vertically over at least 60 mm.

22. The protective and/or handling cover according to claim 20, wherein the continuous resting surface extends horizontally over at least 60 mm.

23. The protective and/or handling cover according to claim 20, wherein the rod of the second handle shows a cross-sectional profile that is polygonal with rounded corners.

24. The protective and/or handling cover according to claim 20, wherein the housing comprises:
an opening on the front face, for receiving a dial or display of the tap, the rod of the second handle being located at a height of said opening.

25. The protective and/or handling cover according to claim 20, wherein the rod of the second handle extends generally horizontally below the continuous resting surface.

26. The protective and/or handling cover according to claim 25, wherein the slot shows an average width comprising:
between 10 mm and 20 mm.

27. The protective and/or handling cover according to claim 25, wherein a horizontal section of the continuous resting surface shows a curved profile with a convexity oriented rearwards with an average radius comprising:
between 80 mm and 160 mm.

28. The protective and/or handling cover according to claim 25, wherein the rod of the second handle shows a rear face that is aligned with the continuous resting surface.

29. The protective and/or handling cover according to claim 20, wherein the rod of the second handle extends generally vertically.

30. The protective and/or handling cover according to claim 29, wherein the rod of the second handle extends along and in front of the continuous resting surface.

31. The protective and/or handling cover according to claim 29, wherein the rod of the second handle extends along a whole height of the continuous resting surface.

32. The protective and/or handling cover according to claim 29, wherein the rod of the second handle shows a rear face that is generally flat and a front face that is generally curved or rounded.

33. The protective and/or handling cover according to claim 29, wherein the rod of the second handle extends from a bottom of the housing to the top face of said housing.

34. The protective and/or handling cover according to claim 29, wherein the housing comprises:
two opposite sides faces, each of said side faces comprising:
a bottom edge with a curved profile showing a concavity oriented downwardly.

35. The protective and/or handling cover according to claim 34, wherein each side face of the housing comprises:
a curved protective rib that extends transversally and outwardly from said face.

36. The protective and/or handling cover according to claim 35, wherein the at least one fixation hole is located below the curved protective rib on the side face of said at least one fixation hole.

37. The protective and/or handling cover according to claim 34, wherein each side face of the housing comprises:
at least one fixation hole for receiving a transversal fixation screw to engage with the tap.

38. The protective and/or handling cover according to claim 37, wherein the at least one fixation hole is located below the curved protective rib on the side face of said at least one fixation hole.

39. A gas cylinder assembly, comprising:
a gas cylinder with a top collar;
a tap mounted on the collar of the gas cylinder, with a flow and/or pressure selector;
a protective and/or handling cover housing the tap and comprising:
a housing receiving the tap, with a front face, a rear face and a top face with an opening receiving the flow and/or pressure selector of the tap;
a first handle located at the top of the housing for handling the gas cylinder assembly;
a second handle located on the rear face of the housing, for handling the gas cylinder assembly, said handle comprising a rod forming with a portion of the housing a slot so that said rod can be grasped and encircled through said slot by the fingers of an operator;
wherein the portion of the housing forming the slot forms a continuous surface that extends vertically so as to form a resting surface for the operator's hand, and the cover is attached directly to the tap.
